(19) United States
(12) Patent Application Publication
(10) Pub. No.: US 2011/0201382 A1
(43) Pub. Date: Aug. 18, 2011

(54) PORTALBE SENSOR APPARATUS WITH DETACHABLE SENSOR UNITS

(75) Inventor: Hsiung HSIAO, Hsinchu (TW)

(73) Assignee: Middleland Sensing Technology Inc.

(21) Appl. No.: 12/775,518

(22) Filed: May 7, 2010

(30) Foreign Application Priority Data
Feb. 12, 2010 (TW) 099104639

(51) Int. Cl. G08C 19/00; H04M 1/02; G06F 13/12

(52) U.S. Cl. 455/556.1; 340/870.01; 710/63

(57) ABSTRACT

An exemplary portable sensor apparatus with detachable and interchangeable sensor unit(s) connected through USB interface. The portable electronic device and the sensor unit(s) have pairing USB port and USB plug respectively, for facilitating digital signal transmission between the sensor unit(s) and the portable electronic device. The sensor unit(s) includes a sensor probe for real-time measuring or monitoring physical and/or chemical parameters of a target object, and an analog-to-digital (A/D) converter to convert the signals into digital ones. The portable electronic device includes a storage unit and a processing unit. The storage unit is for storing multiple programs and data for different sensing applications. The processing unit is for receiving digital signals, selecting an appropriate program from the storage unit, analyzing the digital signals by the selected program and thereby acquiring data from the measurement.

### CROSS-REFERENCE TO RELATED APPLICATION

This application claims the priority benefit of Taiwan application serial no. 099104639, filed on Feb. 12, 2010. The entirety of the above-mentioned patent application is incorporated herein by reference and made a part of this specification.

### BACKGROUND

1. Technical Field

The present invention generally relates to a portable apparatus with real time sensor functions, and, particularly to a portable sensor apparatus with a detachable and interchangeable sensor unit(s).

2. Description of the Related Art

A conventional portable sensor apparatus generally includes a sensor unit, a display unit and a signal processing unit. The sensor unit has a sensor probe and is for measuring or monitoring physical and chemical parameters of a target object. The signal processing unit is configured to process signals obtained from the sensor unit and sometimes, to analyze and to store the resulted data. The display unit has a display screen and is for displaying results of the sensing process. During the measuring process, the user can visualize acquired data displayed on screen.

However, a portable sensor apparatus usually has the sensor unit, the processing unit, and the display unit integrally built, i.e., different types of the sensor units are coupled with different types of processing units and display units respectively, which are not interchangeable. The function of a portable sensor apparatus is hence limited by the type of sensor probes attached, which results in limited applications of a single sensor apparatus. When multiple analytes are involved, such as chemical compositions of both liquid samples and gas samples, different portable sensor apparatuses are usually required, which inevitably increases cost and reduces mobility, and hence results in inconvenience for users.

### BRIEF SUMMARY

Accordingly, the present invention is directed to a portable electronic device with mobile communication function, which is connected with interchangeable sensor units that can be detached from and installed onto said device, thereof, a consumer electronic device with mobile communication function becomes a multifunctional sensor apparatus when coupled with different sensor units.

Specifically, a sensor apparatus in accordance with an embodiment of the present invention includes a portable electronic device with mobile communication function, a universal serial bus (USB) transmission interface and a real-time sensor unit. The USB transmission interface includes a USB port and a USB plug. The pairing USB port and USB plug are built on the pairing electronic device and sensor unit respectively.

The sensor unit further includes a sensor probe besides the USB plug (or the USB port). The USB plug is configured for detachably being plugged in the USB port to establish an electrical connection between the sensor unit and the portable electronic device, and thereby achieving digital data transmission between the sensor unit and the portable electronic device.

The sensor probe is configured for acquiring certain physical and chemical parameters, the sensor unit then generates digital signals according to the acquired parameters.

The portable electronic device at least includes a storage unit and a processing unit. The storage unit is configured for storing multiple programs respectively for different sensor applications. The processing unit is configured for receiving digital signals generated from the sensor unit, selecting an appropriate program from the storage unit according to the digital signals, analyzing the digital signals from the sensor unit by using the selected program and thereby acquiring physical and chemical parameters of the target object in a real-time manner.

In one embodiment, the portable electronic device further includes a display unit configured for displaying data resulted from the analysis.

In one embodiment, the portable electronic device further includes a recognizing unit configured for recognizing the type of the sensor unit being attached through USB interface and thereby facilitating the processing unit to select appropriate programs from the storage unit.

In one embodiment, the sensor unit is one of chemical sensors, such as ion sensors, gas sensors and biosensors.

In one embodiment, the chemical sensors include sensors for measuring physical and chemical parameters of blood, urine, or other body fluids, and sensors for measuring physiological signals such as blood pressure or body temperature.

In one embodiment, the sensor unit further includes an analog-to-digital (A/D) converter configured for converting the analog signals delivered by the sensor probe into digital signals.

In one embodiment, the portable electronic device is a mobile phone.

In one embodiment, the mobile phone has a global positioning system (GPS) module, a camera module and a wireless communication module built therein.

In summary, since the sensor units can be detachably installed onto a portable electronic device with mobile communication function, when the sensor apparatus in accordance with the present invention is used in a situation when multiple parameters are to be measured, only one portable electronic device is required to be coupled with different sensor units, and thus the cost, size and weight are decreased while number of functions, expandability and efficiency are increased.

Other objectives, features and advantages of the present invention will be further understood from further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic assembly diagram of a portable sensor apparatus in accordance with a first embodiment of the present invention.

FIG. 2 is a schematic view of a portable electronic device and a sensor unit of FIG. 1.

FIG. 3 is a schematic view of a portable electronic device and a sensor unit of a portable sensor apparatus in accordance with a second embodiment of the present invention.

FIG. 4 is a schematic view of a portable electronic device and a sensor unit of a sensor apparatus in accordance with a third embodiment of the present invention.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

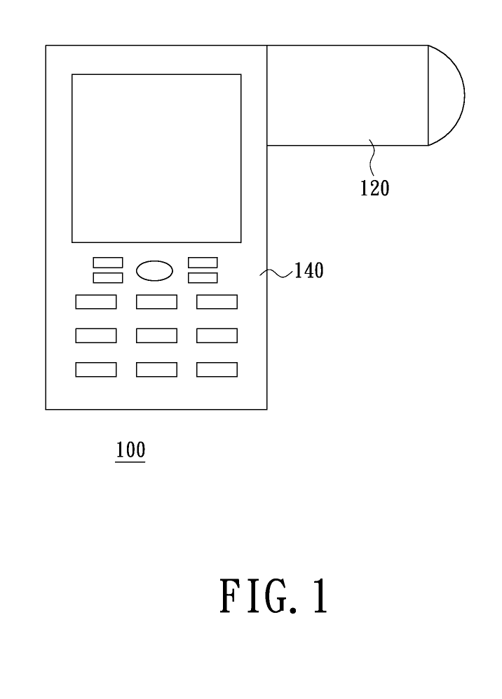

FIG. 1 is a schematic assembly diagram of a portable sensor apparatus in accordance with a first embodiment of the present invention. As illustrated in FIG. 1, a sensor apparatus 100 includes a sensor unit 120 and a portable electronic device 140. The sensor unit 120 is for the measurement of physical and chemical parameters of a target object. The portable electronic device 140 is configured for combining with multiple sensor units 120, processing digital signals obtained by the respective sensor units 120, analyzing parameters of the respective target objects and displaying the resulted data.

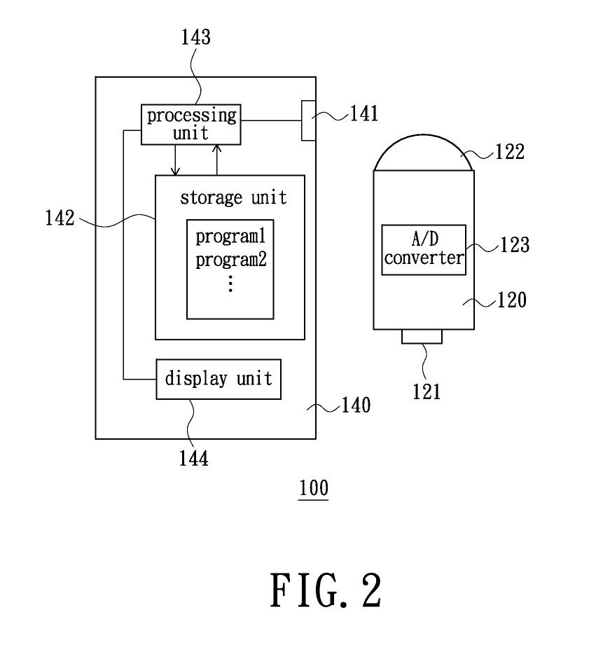

FIG. 2 is a schematic view of the portable electronic device 140 and the sensor unit 120 of FIG. 1. As illustrated in FIG. 2, the sensor unit 120 and the portable electronic device 140 are connected with each other by means of a universal series bus (USB) transmission interface. The USB transmission interface includes a USB plug 121 and a USB port 141. In the illustrated embodiment, the USB plug 121 is formed on the sensor unit 120, and the USB port 141 is formed on the portable electronic device 140.

The USB plug 121 of the sensor unit 120 can be plugged into or unplugged from the USB port 141 of the portable electronic device 140, so that the sensor unit 120 can be detachably electrically connected to the portable sensor device 140. When the USB plug 121 is plugged into the USB port 141, the digital signal transmission between the sensor unit 120 and the portable electronic device 140 is achieved.

The sensor unit 120 further includes a sensor probe 122 and an analog-to-digital (A/D) converter 123. The sensor probe 122 is configured for the measurement or monitoring of physical and chemical parameters of a target object and generating analog signals corresponding to the parameters. Such analog signals generally are micro-voltage signals or micro-current signals. The analog signals e.g., the micro-voltage or micro-current signals are converted into digital signals by the A/D converter 123.

In the illustrated embodiment, the portable electronic device 140 is for example a mobile phone that includes a storage unit 142, a processing unit 143 and a display unit 144. The storage unit 142 is for storing one or more programs, such programs are respectively corresponding to different sensor units 120. The processing unit 143 receives the digital signals from the installed sensor unit 120 through the electrical connection between the USB port 141 and the USB plug 121, selects an appropriate program from the storage unit 142 manually or automatically according to the digital signals, analyzes the digital signals by the selected program, acquires parameters of a target object, and controls the display unit 144 to display the analyzing results from the processing unit 143.

The real-time characteristic associated with the sensor apparatus is that the sensor probe 122 can respond to changes of physical and chemical parameters of target objects and produce analog signals almost simultaneously.

It is noted that, in the illustrated embodiment, the type of sensor unit 120 and the parameters measured by the sensor unit 120 are changed when different types of sensor probes 122 are chosen for different applications respectively. In the illustrated embodiment, the sensor unit 120 is for example a chemical sensor which can be an ion sensor, a gas pressure sensor or a biosensor such as a blood glucose sensor, a blood oxygen sensor or a urea sensor, but not limited to these examples. Corresponding to the types of sensor units, parameters measured by sensor probes are for example chemical composition, liquid medicine concentration, ion composition, ion concentration, gas composition, gas concentration, gas humidity, gas pressure, blood glucose concentration, blood oxygen saturation, or protein concentration of a target object, and so on. The programs stored in the storage unit 142 are corresponding to the respective sensor units and for facilitating the processing unit 143 to analyze acquired parameters.

A measuring process associated with the real-time sensor apparatus of the present embodiment will be described below in details by taking a sensor apparatus used for measuring chemical composition and gas pressure of a target object as an example.

Firstly, the USB plug 121 of the sensor unit 120 is plugged into the USB port 141 of the portable electronic device 140, so that the sensor unit 120 is assembled to the portable electronic device 140. The sensor probe 122 then is in contact with a target object to obtain an analog signal corresponding to a chemical composition of the target object. The analog signal can be micro-voltage or micro-current signals. Afterwards, the analog signals are converted into digital signals through the A/D converter 123. The digital signals will be delivered to the processing unit 143 of the portable electronic device 140 through the electrical connection between the USB port 141 and the USB plug 121. A program from the storage unit 142 is selected manually or automatically and used for analyzing chemical composition according to the received digital signals. Obtained information corresponding to the chemical composition of the target object is displayed by the display unit 144. Hereto, the measurement of chemical composition is completed. Subsequently, the sensor unit 120 used for the measurement of chemical composition is unplugged from the portable electronic device 140, and another sensor unit 120 for measuring gas pressure is plugged onto the portable electronic device 140 for next measurement task.

Since the sensor unit 120 is detachably installed onto the portable electronic device 140, under the circumstances when different types of physical and/or chemical parameters are involved, only one portable electronic device 140 is needed to be coupled with different sensor units. Hence, the size and weight are reduced, which greatly facilitates mobility for field tasks.

In addition, since a common portable consumer electronic device, e.g. a mobile phone, already includes aforementioned processing unit, storage unit and display unit, it can be easily expanded into a multi-functional sensor apparatus, when coupled with different sensor units designed for different sensor applications. Hence, unnecessary waste and cost for building multiple types of sensor apparatuses are avoided.

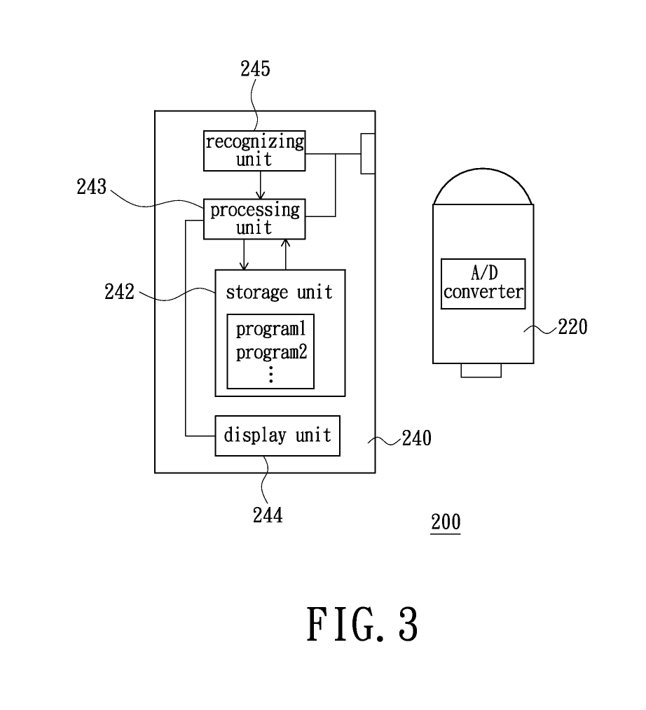

FIG. 3 is a schematic view of a portable electronic device and a sensor unit of a portable sensor apparatus in accordance with a second embodiment of the present invention. As illustrated in FIG. 3, the sensor apparatus 200 is similar to the sensor apparatus 100 in accordance with the first embodiment except for the portable electronic device 240. In the second embodiment, the portable electronic device 240 further includes a recognizing unit 245 configured for recognizing the type of sensor unit 220 and then facilitating the processing unit 243 to select an appropriate program from the storage unit 242.

During a measuring or monitoring process performed by the sensor apparatus 200, digital signals from the sensor unit 220 enable the recognizing unit 245 to automatically recognize the type of the sensor unit 220, and to transmit information associated with the type of the sensor unit 220 to the processing unit 243. An appropriate program is selected from the storage unit 242 to analyze the digital signals, and to obtain relevant information about the physical or chemical parameters of a target object. The resulted data is displayed by the display unit 244.

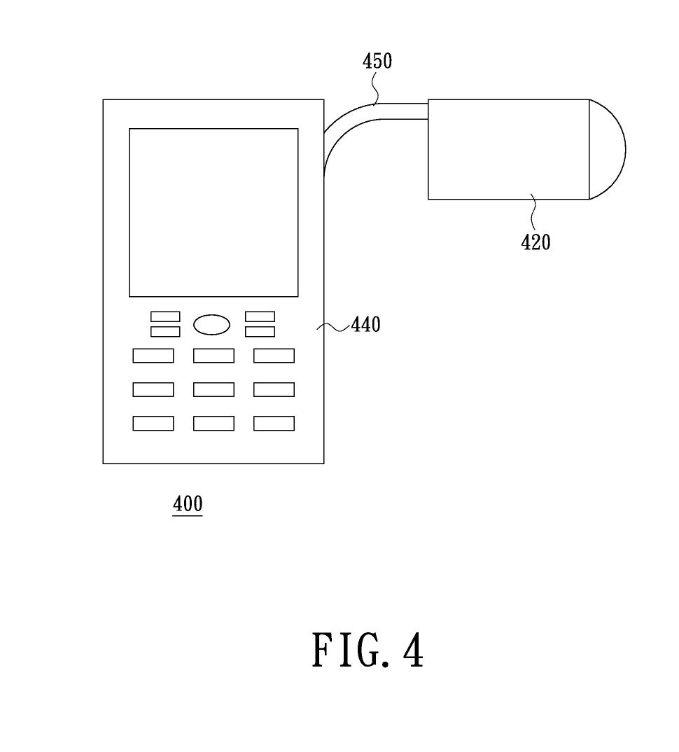

Moreover, instead of plugging the sensor unit 120 directly onto the portable electronic device 140 as illustrated in FIG. 1, a sensor unit 420 of a portable sensor apparatus 400 can be connected with a portable electronic device 440 through an USB cable 450, as illustrated in FIG. 4.

It is indicated that, in the above-mentioned embodiments, only the sensor functions of the portable sensor apparatus in accordance with the present invention is described. However, in practical applications, in order to analyze and assess a target object in a better way, the portable electronic device of the sensor apparatus in accordance with the present invention can further include a camera module, a wireless communication module and/or a global positioning system (GPS) module equipped therewith, facilitating a better evaluation and judgment in time for persons not present at the operation site.

For example, the camera module built in a mobile phone coupled with sensor units allows photos taken of a target object and/or surrounding environment and hence, provides more comprehensive information to help a fellow researcher at a remote site to analyze the target object and to make judgments more easily.

The wireless communication module built in a mobile phone coupled with sensor units facilitates the information obtained by the apparatus to be transmitted to other people in time through a wireless network and thus the timeliness of information sharing is improved.

The GPS module built in a mobile phone coupled with sensor units allows performing positioning applied to the apparatus, which facilitates other people at remote sites to acquire the location of the target object in time, so that the researcher can include geographic information for consideration when analyzing the data obtained from the measurement.

In summary, the portable sensor apparatus in accordance with the embodiments of the present invention can achieve at least one of advantages as follows: (1) Since the sensor unit is detachably installed onto the portable electronic device, under the circumstances when multiple types of measurements are involved, only one portable electronic device is needed, the size and weight are reduced, which increases the efficiency of a measurement task. (2) Since a common portable consumer electronic device already includes aforementioned processing unit, storage unit and display unit, it can be easily expanded into a multi-functional sensor apparatus, when coupled with different types of sensor units. Hence, the cost associated with manufacturing and purchasing multiple types of sensor apparatuses is reduced. Measurements relying on chemical sensors thus become much more economical. (3) In addition to the sensor units aforementioned, the real-time sensor apparatus in accordance with the present invention can be equipped with other functional module(s), which is commonly associated with a PDA or a smart mobile phone, so that the sensor apparatus can easily satisfy additional requirements of users.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A portable sensor apparatus comprising:
a portable electronic device; and
a sensor unit, connected with the portable electronic device through a USB transmission interface, wherein the sensor unit comprises a sensor probe configured for measuring and/or monitoring physical and/or chemical parameters of a target object, the sensor unit generates digital signals according to the measured parameters and transmits the digital signals to the portable electronic device through the USB transmission interface;
wherein the portable electronic device comprises:
a storage unit, for storing a plurality of programs respectively used for different sensing applications; and
a processing unit, for receiving the digital signals, selecting one of the programs from the storage unit according to the digital signals and obtaining information of the target object by using the selected program.

2. The portable sensor apparatus as claimed in claim 1, wherein the portable electronic device further comprises a display unit configured for displaying data resulted from measurements.

3. The portable sensor apparatus as claimed in claim 1, wherein the portable electronic device further comprises a recognizing unit configured for recognizing the type of the sensor unit and then facilitating the processing unit to select one of the programs.

4. The portable sensor apparatus as claimed in claim 1, wherein the sensor unit is one of chemical sensors.

5. The portable sensor apparatus as claimed in claim 1, wherein the sensor unit further comprises an analog-to-digital converter configured for converting analog signals representative of the target object into digital signals.

6. The portable sensor apparatus as claimed in claim 1, wherein the portable electronic device is a mobile phone.

7. The portable sensor apparatus as claimed in claim 6, wherein the mobile phone has a global positioning system module, a camera module and a wireless communication module built therein.

8. The portable sensor apparatus as claimed in claim 1, wherein the USB transmission interface comprises a USB plug and a USB port.

9. The portable sensor apparatus as claimed in claim 8, wherein the USB transmission interface further comprises a USB cable.

10. A portable sensor apparatus comprising:
a portable electronic device; and
a sensor unit, detachably connected with the portable electronic device for electrical connection;
wherein the sensor unit is configured for producing signals representative of physical and/or chemical parameters of a target object and transmitting the signals to the portable electronic device, and the portable electronic device is configured for calling a particular program stored therein to process the signals and thereby acquiring information of the target object.

11. The portable sensor apparatus as claimed in claim 10, wherein the sensor unit is detachably and interchangeably connected with the portable electronic device by a USB transmission interface.
